(19) United States
(12) Patent Application Publication
(10) Pub. No.: US 2020/0403932 A1
(43) Pub. Date: Dec. 24, 2020

(54) SYSTEM FOR ENABLING AND DISABLING FLEXIBLE BANDWIDTH SHARED BY MULTIPLE CONTROL TERMINALS AND METHOD THEREFOR

(71) Applicant: GUANGZHOU SHUYUANCHANGLIAN SCIENCE AND TECHNOLOGY CO., LTD., Guanzghou (CN)

(72) Inventors: Hui Chen, Guangzhou (CN); Jian Sun, Tianjin (CN); Yirong Zou, Guangzhou (CN); Xingyu Liu, Shaoshan (CN)

(21) Appl. No.: 16/764,139

(22) PCT Filed: Aug. 13, 2018
(86) PCT No.: PCT/CN2018/100194

§ 371 Date: May 14, 2020

(30) Foreign Application Priority Data
Sep. 21, 2017 (CN) 201710857403.1

(51) Int. Cl. H04L 12/919; H04L 12/927; H04L 12/911

(52) U.S. Cl. CPC H04L 47/765; H04L 47/826; H04L 47/803

(57) ABSTRACT

The present invention discloses a system and a method for opening and closing an elastic bandwidth shared by multiple control terminals. The method includes: a terminal, the terminal sending a related instruction; and an elastic bandwidth controller, the elastic bandwidth controller receiving the instruction sent by the terminal and performing corresponding processing. The present invention can both solve the problem of conflicts among multiple applications and automatically close unnecessary invalid consumption, the opening and closing of the bandwidth can be efficiently controlled, and the degree of automation is relatively high.

### CROSS-REFERENCE TO RELATED APPLICATIONS

This application is a 371 of International Patent Application No. PCT/CN2018/100194 with a filing date of Aug. 13, 2018, designating the United States, now pending, and claims priority to Chinese Patent Application No. 201710857403.1 with a filing date of Sep. 21, 2017. The content of the aforementioned applications, including any intervening amendments thereto, are incorporated herein by reference.

### TECHNICAL FIELD

The present invention relates to a system and a method for opening and closing an elastic bandwidth shared by multiple control terminals.

### BACKGROUND

In the prior art, on the same elastic bandwidth link, there may be multiple applications that need to actively control an elastic bandwidth of the link to be opened and closed. When there is only one single application on the elastic bandwidth link, there is no problem with the opening and closing of the elastic bandwidth. The elastic bandwidth can be opened and closed by sending an instruction from the application at any time. However, when there are multiple applications controlling the opening and closing of the elastic bandwidth at the same time, the problem of conflicts will be immediately faced: when application A ends and closes the elastic bandwidth, application B or more applications have not ended the use state of the elastic bandwidth, and the elastic bandwidth can only be closed after they are all ended. There needs to be a method to solve the problem of the conflicts among multiple applications. Since it must be assumed that the application software is not developed by the same company, it must be assumed that no synergic relationship exists between the applications, which means that the conflicts should not be coordinated from the application side.

The elastic bandwidth is opened and closed by sending an instruction from the application. If the application does not send the instruction to close the elastic bandwidth due to various reasons such as software logic errors or operational errors after opening the elastic bandwidth, the elastic bandwidth will always be in the closed state. There is a need for a method to automatically close such invalid consumption.

Therefore, it is an urgent problem to be solved in the industry to design a system and a method for opening and closing the elastic bandwidth shared by the applications, which can both solve the problem of the conflicts among multiple applications and automatically close unnecessary invalid consumption.

### SUMMARY

The present invention provides a system for opening and closing an elastic bandwidth shared by multiple control terminals, including: a terminal; and an elastic bandwidth controller, wherein the elastic bandwidth controller is connected to the terminal.

In a preferred embodiment of the present invention, a connection manner between the elastic bandwidth controller and the terminal is TCP, UDP or URL.

The present invention further provides a method for opening and closing an elastic bandwidth shared by multiple control terminals, including: a terminal, wherein the terminal sends a related instruction; and an elastic bandwidth controller; wherein the elastic bandwidth controller receives the instruction sent by the terminal and performs corresponding processing.

In a preferred embodiment of the present invention, the connection manner between the elastic bandwidth controller and the terminal is TCP, UDP or URL.

In a preferred embodiment of the present invention, the instruction sent by the terminal includes: an application identification number, wherein each terminal corresponds to a unique application identification number when on the same line; and each terminal does not need to correspond to the unique application identification number when on different lines; a line identification number, wherein the line identification number corresponds to each elastic bandwidth line; an authorization code, wherein the authorization code identifies instruction authorization rather than counterfeiting; a countdown module, wherein when the countdown module determines that the access time is less than 0, the elastic bandwidth will be automatically closed; otherwise, the elastic bandwidth will be automatically opened; and a main control module, connected to the application identification number, the line identification number, the authorization code, and the countdown module.

In a preferred embodiment of the present invention, the step that the elastic bandwidth controller processes the instruction comprises: step 1: searching for the same line identification number and application identification number in a record table; and step 2: creating the same line identification number and application identification number if not searched, and saving the line identification number; the application identification number and the countdown module; and replacing original information in the record with the countdown module in the instruction if searched.

Compared with the prior art, the present invention has the following advantages:

The present invention can both solve the problem of conflicts among multiple applications and automatically close unnecessary invalid consumption, the opening and closing of the bandwidth can be efficiently controlled, and the degree of automation is relatively high.

### BRIEF DESCRIPTION OF THE DRAWINGS

FIG. 1 is a schematic diagram of the principle of an instruction sent by a terminal of the present invention.

FIG. 2 is a schematic diagram of instruction processing of an elastic bandwidth controller of the present invention.

FIG. 3 is a schematic diagram of a system for opening and closing an elastic bandwidth shared by multiple control terminals of the present invention.

### DETAILED DESCRIPTION

In order to more fully understand the technical content of the present invention, the present invention will be further described below with reference to the drawings, but is not limited thereto.

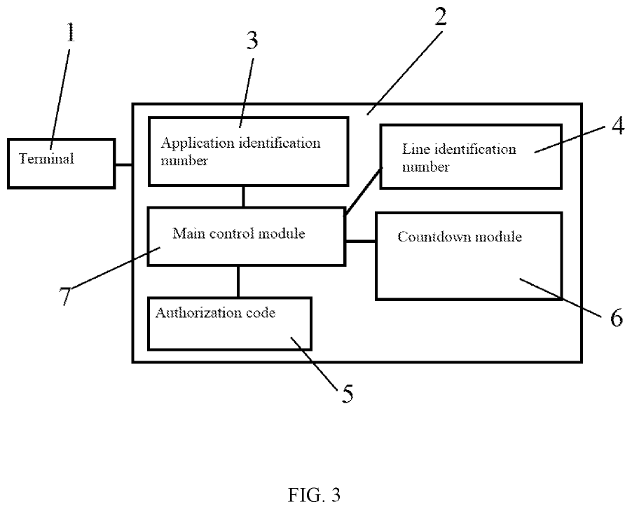

As shown in FIG. 3, a system for opening and closing an elastic bandwidth shared by multiple control terminals according to the present invention includes: a terminal 1; an elastic bandwidth controller 2, which is connected to the terminal 1.

As shown in FIG. 3, in a preferred embodiment of the present invention, the connection manner between the elastic bandwidth controller 2 and the terminal 1 is TCP, UDP, or URL.

The present invention also provides a method for opening and closing an elastic bandwidth shared by multiple control terminals, including: a terminal 1, wherein the terminal 1 sends a related instruction; and an elastic bandwidth controller 2, wherein the elastic bandwidth controller 2 receives the instruction sent by the terminal 1 and performs corresponding processing.

As shown in FIG. 3, in a preferred embodiment of the present invention, the connection manner between the elastic bandwidth controller 2 and the terminal 1 is TCP, UDP, or URL.

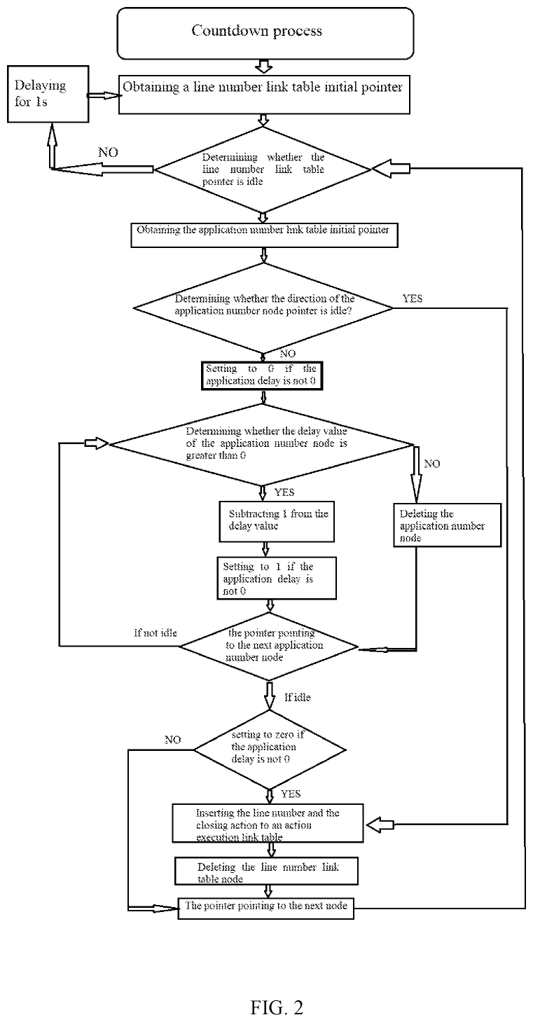

With reference to FIG. 2 and FIG. 3, in a preferred embodiment of the present invention, the instruction sent by the terminal 1 includes: an application identification number 3, wherein each terminal 1 corresponds to a unique application identification number 3 when on the same line; and each terminal 1 does not need to correspond to the unique application identification number 3 when on different lines; a line identification number 4, wherein the line identification number 4 corresponds to each elastic bandwidth line; an authorization code 5, wherein the authorization code 5 identifies instruction authorization rather than counterfeiting; a countdown module 6, wherein when the countdown module 6 determines that the access time is less than 0, the elastic bandwidth will be automatically closed; otherwise, the elastic bandwidth will be automatically opened; and a main control module 7, connected to the application identification number 3, the line identification number 4, the authorization code 5, and the countdown module 6.

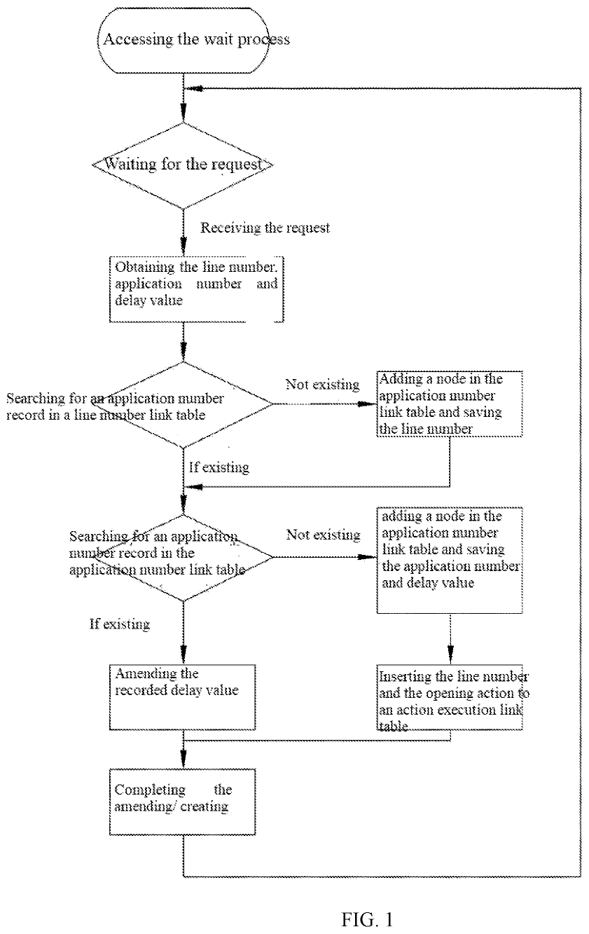

With reference to FIG. 1 and FIG. 3, in a preferred embodiment of the present invention, the step that the elastic bandwidth controller 2 processes the instruction includes: step 1: searching for the same line identification number 4 and application identification number 3 in a record table; and step 2: creating the same line identification number 4 and application identification number 3 if not searched, and saving the line identification number 4, the application identification number 3 and the countdown module 6; and replacing original information in the record with the countdown module 6 in the instruction if searched.

In summary, the present invention can both solve the problem of conflicts among multiple applications and automatically close unnecessary invalid consumption, the opening and closing of the bandwidth can be efficiently controlled, and the degree of automation is relatively high.

The above specific embodiments are only used to illustrate the concept of the present invention, and those of ordinary skill in the art could make various modifications and changes under the concept of the present invention. These modifications and changes are included in the protection scope of the present invention.

We claim:

1. A system for opening and closing an elastic bandwidth shared by multiple control terminals, comprising:
a terminal (1); and
an elastic bandwidth controller (2), wherein the elastic bandwidth controller (2) is connected to the terminal (1).

2. The system for opening and closing an elastic bandwidth shared by multiple control terminals according to claim 1, wherein a connection manner between the elastic bandwidth controller (2) and the terminal (1) is TCP, UDP or URL.

3. A method for opening and closing an elastic bandwidth shared by multiple control terminals, comprising:
a terminal (1), wherein the terminal (1) sends a related instruction; and
an elastic bandwidth controller (2), wherein the elastic bandwidth controller (2) receives the instruction sent by the terminal (1) and performs corresponding processing.

4. The method for opening and closing an elastic bandwidth shared by multiple control terminals according to claim 3, wherein the connection manner between the elastic bandwidth controller (2) and the terminal (1) is TCP, UDP or URL.

5. The method for opening and closing an elastic bandwidth shared by multiple control terminals according to claim 3, wherein the instruction sent by the terminal (1) comprises:
an application identification number (3), wherein each terminal (1) corresponds to a unique application identification number (3) when on the same line; and each terminal (1) does not need to correspond to the unique application identification number (3) when on different lines;
a line identification number (4), wherein the line identification number (4) corresponds to each elastic bandwidth line;
an authorization code (5), wherein the authorization code (5) identifies instruction authorization rather than counterfeiting;
a countdown module (6), wherein when the countdown module (6) determines that the access time is less than 0, the elastic bandwidth will be automatically closed; otherwise, the elastic bandwidth will be automatically opened; and
a main control module (7), wherein the main control module (7) is connected to the application identification number (3), the line identification number (4), the authorization code (5), and the countdown module (6).

6. The method for opening and closing an elastic bandwidth shared by multiple control terminals according to claim 3, wherein the step that the elastic bandwidth controller (2) processes the instruction comprises:
step 1: searching for the same line identification number (4) and application identification number (3) in a record table; and
step 2: creating the same line identification number (4) and application identification number (3) if not searched, and saving the line identification number (4), the application identification number (3) and the countdown module (6); and replacing original information in the record with the countdown module (6) in the instruction if searched.
